(19) United States
(12) Patent Application Publication
(10) Pub. No.: US 2006/0268441 A1
(43) Pub. Date: Nov. 30, 2006

(54) Additive in-car rearview mirror

(75) Inventor: Pure Chao, Taipei City (TW)

Correspondence Address: BRUCE H. TROXELL, SUITE 1404, 5205 LEESBURG PIKE, FALLS CHURCH, VA, 22041, US

(73) Assignee: Kaisers International Corporation

(21) Appl. No.: 11/395,231

(22) Filed: Apr. 3, 2006

(30) Foreign Application Priority Data
May 25, 2005 (TW) 94208586

(51) Int. Cl. G02B 7/182

(52) U.S. Cl. 359/879; 359/871

(57) ABSTRACT

An additive in-car rearview mirror including a rearview mirror main body, a press member and two movable levers. The rearview mirror main body is recessed to form a receiving space having an opening. Two opposite support shafts are disposed in the receiving space. Two arced slots are formed respectively on outer sides of the support shafts. Two fixed press boards are formed on rear side of the main body under the arced slots. A mirror is mounted at the opening. The press member extends from outer side into the main body between the two support shafts. A resilient member is compressed between the press member and the main body for resiliently pushing the press member outward. The middle sections of the movable levers are pivotally connected with the support shafts. First ends of the movable levers are pivotally connected with the press member. Second ends of the movable levers respectively extend to the arced slots to pivotally connect with two movable press boards outward extending through the arced slots. By means of pressing or releasing the press member, the movable press boards are moved toward or away from the fixed press boards for clamping or releasing an article.

### BACKGROUND OF THE INVENTION

The present invention is related to an additive in-car rearview mirror which has simple structure and can be easily operated.

Taiwanese Utility Model Patent No. 549262 ( Application No. 90218742) discloses a car-used rearview mirror with hidden liquid crystal display. The rearview mirror includes an outer shade having an opening. The outer shade is formed with at least one internal receiving chamber. Multiple fixing posts are formed on the bottom of each receiving chamber. At least one clamping device is disposed on the outer shade. The clamping device is composed of an upper clamping member and a lower clamping member. The lower clamping member is fixedly disposed on the outer shade. A slide channel is formed on the bottom face of the outer shade. The upper clamping member is slidably received in the slide channel for adjusting the distance between the upper and lower clamping members. One end of a spring is hooked on the upper clamping member. The other end of the spring is hooked on the outer shade, whereby the spring provides a resilient restoring force for clamping an article. A terminal is fixed on the outer shade for connecting with a signal source. A transparent reflective mirror is mounted at the opening of the outer shade. At least one liquid crystal display is mounted in the outer shade and connected with the terminal for receiving signals. When the liquid crystal display is turned on, a picture is sent from the terminal to the liquid crystal display. Via the reflective mirror, a user can see the picture of the liquid crystal display. After the liquid crystal display is turned off, the liquid crystal display is hidden to serve as a mirror.

When mounted on the original rearview mirror, the upper and lower clamping members must be pulled apart to clamp the original rearview mirror. Such operation must be performed with both hands. Therefore, it is inconvenient for the user to add the liquid crystal display to the original rearview mirror.

Moreover, the upper and lower clamping members are parallel to each other. In the case that the original rearview mirror has a nonlinear periphery, the upper and lower clamping members will simply clamp the original rearview mirror at some points. Therefore, the clamping device can hardly firmly clamp the original rearview mirror.

Furthermore, the upper and lower clamping members are independent members. Each of the upper and lower clamping members is equipped with a spring. Therefore, the rearview mirror has many parts which complicate the assembly of the structure. Also, the possibility of failure is increased.

### SUMMARY OF THE INVENTION

It is therefore a primary object of the present invention to provide an additive in-car rearview mirror including a rearview mirror including a rearview mirror main body, a press member and two movable levers. The rearview mirror main body is recessed to form a receiving space having an opening. Two opposite support shafts are symmetrically disposed in the receiving space. Two arced slots are formed respectively on outer sides of the support shafts. Two fixed press boards are formed on rear side of the main body under the arced slots. An at least partially transparent mirror is mounted at the opening of the receiving space to cover the receiving space. A display is arranged in the receiving space for showing messages by way of characters or images. The press member extends from outer side into the main body between the two support shafts. A resilient member is compressed between the press member and the main body for resiliently pushing the press member outward. The middle sections of the movable levers are pivotally connected with the support shafts. First ends of the movable levers are pivotally connected with the press member. Second ends of the movable levers respectively extend to the arced slots to pivotally connect with two movable press boards outward extending through the arced slots. By means of pressing the press member or release the press member, the first ends of the movable levers are driven and the movable press boards of the second ends of the movable levers are moved toward the fixed press boards or away from the fixed press boards for clamping or releasing an article.

The present invention can be best understood through the following description and accompanying drawings wherein:

### BRIEF DESCRIPTION OF THE DRAWINGS

FIG. 1 is a perspective exploded view of the present invention;

FIG. 2 is a perspective partially assembled view of the present invention;

FIG. 3 is a rear perspective assembled view of the present invention;

FIG. 4 is a front view of the present invention, showing that the press member is released in a natural state;

FIG. 5 is a front view of the present invention, showing that the press member is pressed; and

FIG. 6 is a front view of the present invention, showing that the press member is pressed to the bottom and the movable press boards are spaced from the fixed press boards by a maximum distance.

### DETAILED DESCRIPTION OF THE PREFERRED EMBODIMENT

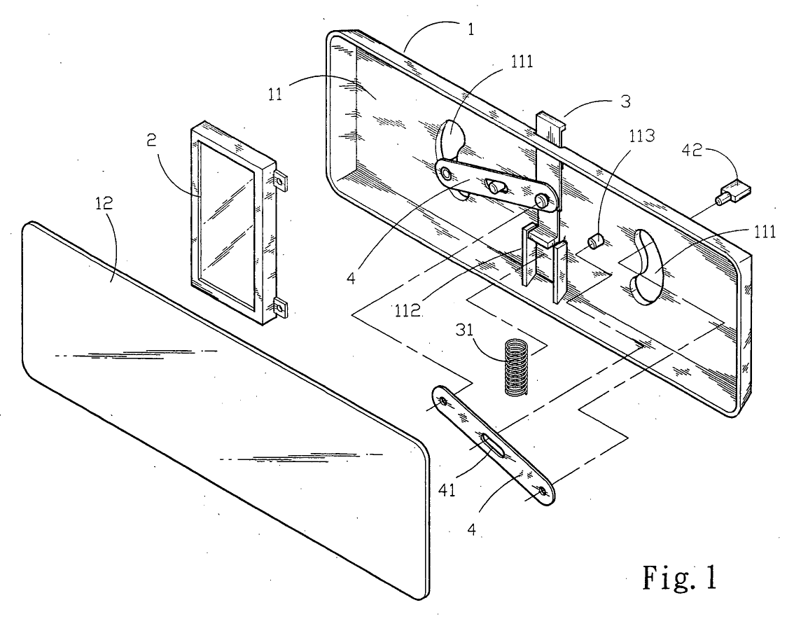

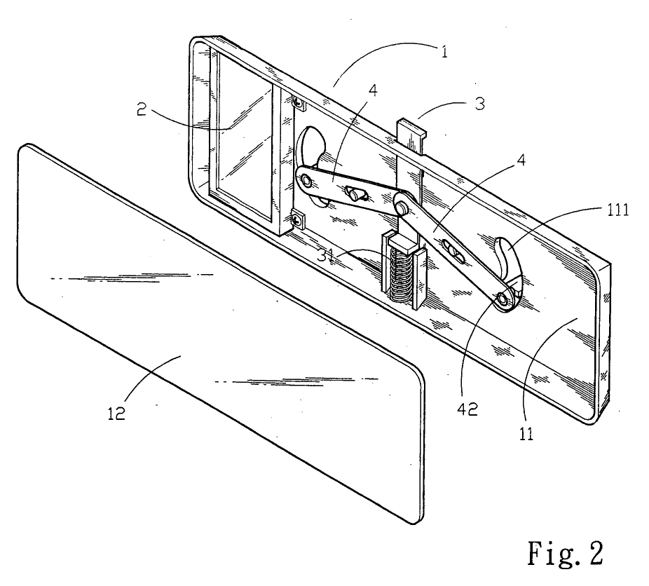

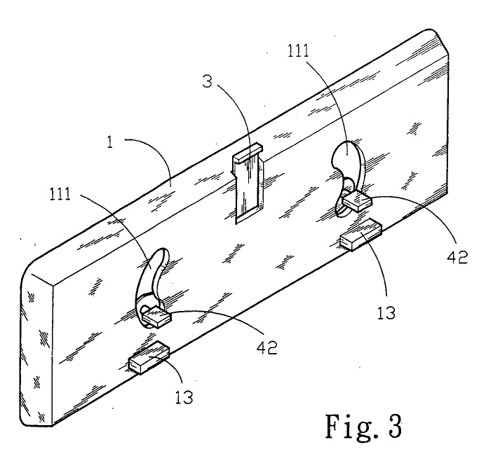

Please refer to FIGS. 1 to 3. The present invention includes a rearview mirror main body 1, a press member 3 and two movable levers 4. The rearview mirror main body 1 is recessed to form a receiving space 11 having an opening 10. Two opposite support shafts 113 are disposed in the receiving space 11. Two parallel ribs 112 are transversely disposed between the support shafts 113. Two arced slots 111 are formed on the bottom of the receiving space 11 respectively on outer sides of the support shafts 113. In addition, two fixed press boards 13 are formed on rear side of the rearview mirror main body 1 under the arced slots 111. A mirror 12 with at least partially transparent effect is mounted at the opening 10 of the receiving space 11 to cover the receiving space 11. A display 2 is arranged in the receiving space 11 corresponding to a transparent region of the mirror 12. The display 12 serves to show messages by way of characters or images. The press member 3 extends from outer side into the rearview mirror main body 1 between the two support shafts 113. A resilient member 31 such as a spring is positioned between the ribs 112 and compressed between an inner end of the press member 3 and the rearview mirror main body 1. In natural state, the resilient member 31 exerts a resilient pushing force onto the inner end of the press member 3, whereby the press member 3 tends to extend out of the main body 1. The middle of each movable lever 4 is formed with a slot 41 in which the support shaft 113 is pivotally fitted. First ends of the movable levers 4 are pivotally connected with the press member 3. Second ends of the movable levers 4 respectively extend to the arced slots 11 to pivotally connect with two movable press boards 42. The movable press boards 42 outward extend through the arced slots 111 and are respectively positioned right above the fixed press boards 13.

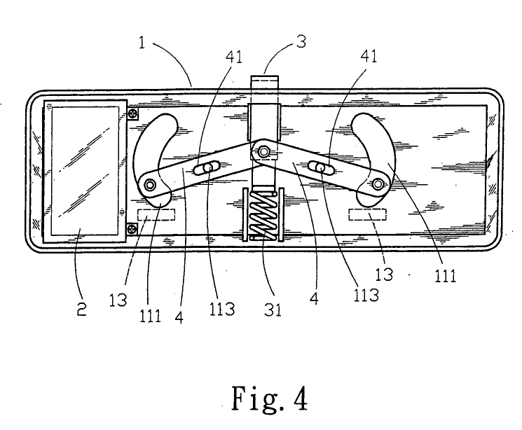

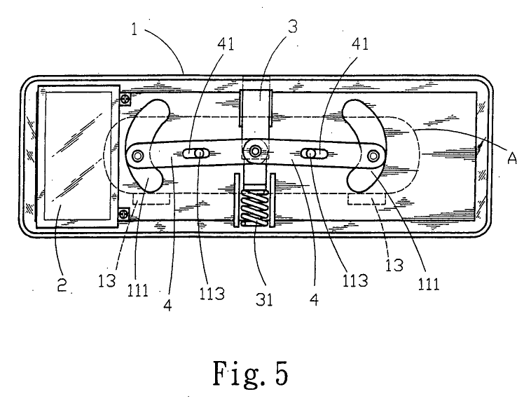

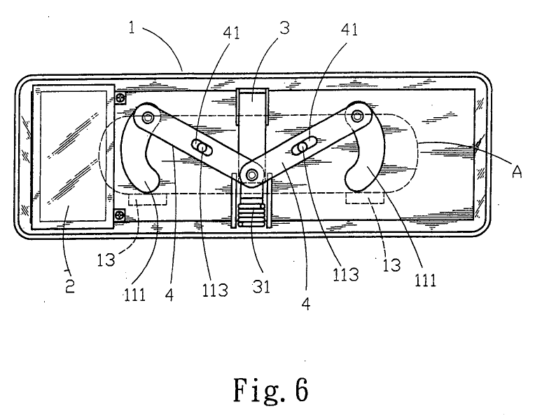

Referring to FIGS. 4 to 6, when the press member 3 is free from external force, the resilient member 31 resiliently pushes the press member 3 upward. At this time, an outer end of the press member 3 protrudes from the rearview mirror main body 1 by a longer length. The press member 3 is linked with the movable levers 4 so that the second ends of the movable levers 4 are descended. Under such circumstance, the movable press boards 42 connected with the second ends are moved toward the fixed press boards 13 to clamp an article. When released, a user can press the press member 3 into the main body 1 with single hand. At this time, the first ends of the movable levers 4 pivotally connected with the press member 3 are moved downward, while the second ends of the movable levers 4 are lifted as shown in FIGS. 5 and 6. Accordingly, the distance between the movable press boards 42 and the fixed press boards 13 is varied with the extent to which the press member 3 is inward pressed. Therefore, the rearview mirror main body 1 can clamp the original rearview mirror A in a certain position. After the press member 3 is released, the resilient member 31 resiliently extends to restore the press member 3 and the movable levers 4. At this time, the movable press boards 42 are moved toward the fixed press boards 13 to clamp the original rearview mirror. Accordingly, the rearview mirror main body 1 can be located on the original rearview mirror.

According to the above arrangement, a user can at the same time with single hand operate the two movable press boards 42 to move toward the fixed press boards 13 or away from the fixed press boards 13. Such operation is convenient to the user. In addition, the movable press boards 42 can be pivoted to comply with the profile of the periphery of the clamped article so as to achieve an optimal clamping effect.

The above embodiments are only used to illustrate the present invention, not intended to limit the scope thereof. Many modifications of the above embodiments can be made without departing from the spirit of the present invention.

What is claimed is:

1. An additive in-car rearview mirror comprising:
a rearview mirror main body which is recessed to form a receiving space having an opening, two opposite support shafts being disposed in the receiving space, two arced slots being formed on a bottom of the receiving space respectively on outer sides of the support shafts, an at least partially transparent mirror being mounted at the opening of the receiving space to cover the receiving space, two fixed press boards being formed on rear side of the rearview mirror main body under the arced slots;
a press member extending from outer side into the rearview mirror main body between the two support shafts, a resilient member being compressed between an inner end of the press member and the rearview mirror main body for resiliently pushing the press member; and
two movable levers, middle sections of the movable levers being respectively pivotally connected with the support shafts, first ends of the movable levers being pivotally connected with the press member, second ends of the movable levers respectively extending to the arced slots to connect with two movable press boards, the movable press boards outward extending through the arced slots, whereby by means of pressing the press member or release the press member, the first ends of the movable levers are driven and the movable press boards of the second ends of the movable levers are moved toward the fixed press boards or away from the fixed press boards for clamping or releasing an article.

2. The additive in-car rearview mirror as claimed in claim 1, wherein a display is arranged in the receiving space of the rearview mirror main body for showing messages by way of characters or images.

3. The additive in-car rearview mirror as claimed in claim 1, wherein the middle section of each movable lever is formed with a slot in which the support shaft of the rearview mirror main body is pivotally fitted.

4. The additive in-car rearview mirror as claimed in claim 2, wherein the middle section of each movable lever is formed with a slot in which the support shaft of the rearview mirror main body is pivotally fitted.

5. The additive in-car rearview mirror as claimed in claim 1, wherein the movable press boards are pivotally connected with the second ends of the movable levers, whereby the movable press boards can be pivoted to comply with the curvature of a periphery of an original in-car rearview mirror so as to more firmly clamp the original in-car rearview mirror.

6. The additive in-car rearview mirror as claimed in claim 2, wherein the movable press boards are pivotally connected with the, second ends of the movable levers, whereby the movable press boards can be pivoted to comply with the curvature of a periphery of an original in-car rearview mirror so as to more firmly clamp the original in-car rearview mirror.

7. The additive in-car rearview mirror as claimed in claim 3, wherein the movable press boards are pivotally connected with the second ends of the movable levers, whereby the movable press boards can be pivoted to comply with the curvature of a periphery of an original in-car rearview mirror so as to more firmly clamp the original in-car rearview mirror.

8. The additive in-car rearview mirror as claimed in claim 4, wherein the movable press boards are pivotally connected with the second ends of the movable levers, whereby the movable press boards can be pivoted to comply with the curvature of a periphery of an original in-car rearview mirror so as to more firmly clamp the original in-car rearview mirror.

9. The additive in-car rearview mirror as claimed in claim 1, wherein two parallel ribs are disposed in the receiving space of the rearview mirror main body between the support shafts for confining the press member and the resilient member within a certain range.

10. The additive in-car rearview mirror as claimed in claim 2, wherein two parallel ribs are disposed in the receiving space of the rearview mirror main body between the support shafts for confining the press member and the resilient member within a certain range.

11. The additive in-car rearview mirror as claimed in claim 3, wherein two parallel ribs are disposed in the receiving space of the rearview mirror main body between the support shafts for confining the press member and the resilient member within a certain range.

12. The additive in-car rearview mirror as claimed in claim 4, wherein two parallel ribs are disposed in the receiving space of the rearview mirror main body between the support shafts for confining the press member and the resilient member within a certain range.

13. The additive in-car rearview mirror as claimed in claim 5, wherein two parallel ribs are disposed in the receiving space of the rearview mirror main body between the support shafts for confining the press member and the resilient member within a certain range.

14. The additive in-car rearview mirror as claimed in claim 6, wherein two parallel ribs are disposed in the receiving space of the rearview mirror main body between the support shafts for confining the press member and the resilient member within a certain range.

15. The additive in-car rearview mirror as claimed in claim 7, wherein two parallel ribs are disposed in the receiving space of the rearview mirror main body between the support shafts for confining the press member and the resilient member within a certain range.

16. The additive in-car rearview mirror as claimed in claim 8, wherein two parallel ribs are disposed in the receiving space of the rearview mirror main body between the support shafts for confining the press member and the resilient member within a certain range.
